(19) United States
(12) Patent Application Publication
(10) Pub. No.: US 2006/0136348 A1
(43) Pub. Date: Jun. 22, 2006

(54) Mailing system user interface

(76) Inventors: Pascal Charroppin, Trumbull, CT (US); Herve Bienaime, Vanves (FR); Laurent Cambon, Montrouge (FR)

Correspondence Address: PERMAN & GREEN, 425 POST ROAD, FAIRFIELD, CT, 06824, US

(21) Appl. No.: 11/243,026

(22) Filed: Oct. 4, 2005

Related U.S. Application Data
(60) Provisional application No. 60/636,419, filed on Dec. 15, 2004.

(51) Int. Cl. G06F 17/00

(52) U.S. Cl. 705/408

(57) ABSTRACT

A method for marking a mailpiece with a marking device is provided. The method includes providing the marking device with a processor and a user interface for inputting and displaying information entering in the user interface a partial sequence of characters from a complete sequence of characters, wherein the complete sequence of characters identifies a predetermined indicia related to a predetermined characteristic of the mailpiece with the processor, using the partial sequence to identify predetermined indicia stored in a memory of the processor that satisfy the partial sequence listing the predetermined indicia on a display of the user interface and selecting one of the listed predetermined indicia, wherein selection of the one listed predetermined indicia causes the processor to generate a corresponding command to the marking device.

### BACKGROUND

1. Field

The disclosed embodiments relate to mailing systems and, more particularly, to a mailing system user interface.

2. Brief Description of Related Developments

The repaid development and expansion in the capabilities of microprocessor controlled systems has generated a demand that the system user interface provide an improved interaction between man and machine (i.e. become more user friendly) in order to ease the burden on the operator to access the system and take full advantage of its capabilities. There are various types of conventional user interfaces. The graphic user interface (GUI) is one type of conventional user interface that has become widely used in various microprocessor controlled processing systems due to inherent ease of use. Microprocessor controlled processing systems include mailing machines that generate and apply by various means a readable indicia to mail pieces allowing the mail pieces to be mailed using a desired service from a mailing service provider such as the USPS. For example, mailing machines enable users to frank one or more mail pieces by printing, or otherwise labeling the mail piece with some indicia representing the amount paid by the sender. For example, U.S. Pat. Nos. 5,243,908; 5,683,190; 5,526,271; 6,607,095; 6,050,054; 5,293,465 and 5,688,729; all of which are incorporated by reference herein in their entirety, disclose franking machines which may comprise franking heads, feeders, inserters, folders and user interfaces. Though the capability to frank mail pieces remains a core function of franking machines, other capabilities have been added such as addressing the mail pieces, labeling the mail pieces with tracking indicia or mail piece specific indicia, that allow the franking machine to be more fully integrated into the mail system of any enterprise. As may be realized, the full capabilities of the franking machine are not desired for every mailing (of one or more mail pieces), and hence selectability of desired capabilities is accomplished via the user interface. However as the machine capability has increased so has the complexity of the user commands to be entered to select the desired machine activities for a given mailing. The exemplary embodiments desired below overcome the problems of conventional mailing systems user interface.

### SUMMARY OF THE INVENTION

In accordance with an exemplary embodiment, a method for marking a mailpiece with a marking device is provided. The method includes providing the marking device with a processor and a user interface for inputting and displaying information entering in the user interface a partial sequence of characters from a complete sequence of characters, wherein the complete sequence of characters identifies a predetermined indicia related to a predetermined characteristic of the mailpiece with the processor, using the partial sequence to identify predetermined indicia stored in a memory of the processor that satisfy the partial sequence listing the predetermined indicia on a display of the user interface and selecting one of the listed predetermined indicia, wherein selection of the one listed predetermined indicia causes the processor to generate a corresponding command to the marking device.

### BRIEF DESCRIPTION OF THE DRAWINGS

The foregoing aspects and other features of the present invention are explained in the following description, taken in connection with the accompanying drawings, wherein:

FIG. 1 is a schematic view of a system for marking mailpiece incorporating features in accordance with an exemplary embodiment;

FIG. 2 is a schematic view of a representative mail piece handled with the system in FIG. 1;

FIG. 3 is a schematic view of a memory arrangement of the system in FIG. 1; and

FIG. 4 is a graphical illustration a method of the user interface of the system in FIG. 1.

### DETAILED DESCRIPTION OF THE EXEMPLARY EMBODIMENT(S)

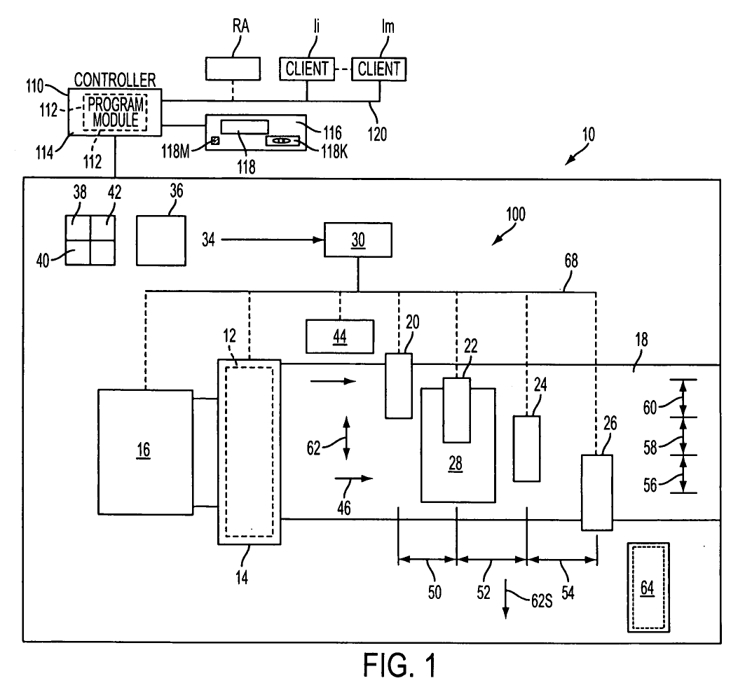

Referring to FIG. 1, a schematic view of a mailing system 10 incorporating features of the disclosed embodiments is illustrated. Although the embodiments disclosed will be described with reference to the embodiments shown in the drawings, it should be understood that the embodiments disclosed can be embodied in many alternate forms of embodiments. In addition, any suitable size, shape or type of elements or materials could be used.

The mailing system 10 in FIG. 1, is generally capable of carrying out mailing(s) 12 of one or more mail pieces 28.

The mailing system 10 shown in FIG. 1 is a representative mailing system and in alternate embodiments the mail system may have any desired configuration. Mailing system 10 generally has a controller 110 and a franking machine 100. The controller 110 is programmable and operably connected to the franking machine 100. The controller 110 has a user interface 116 for a user to input information/user commands to the controller 110, and for the controller to display information to the user. In response to user information/user commands, the controller 110 operates the franking machine to effect mailing(s) 12 (of one or more mail pieces 28). As seen in FIG. 1, the controller 110 may also be communicably connected to a fund account RA (such as a postal fund account) as will be described further below. The controller 110 communicates with the fund account to resolve the accounting for the post amount applied to the franked mail pieces 28 of the given mailing. Each of the mailings 12 carried out with the mailing system 10 may have a corresponding franking criteria. As will be described below the franking criteria of a given mailing 12 may be related to some characteristic of the mailing. The controller 110 and franking machine 100 may be able to perform other actions related to carrying out respective mailing(s) 12 as will also be described below. Desired ones of these other actions to be performed with a given mailing may also vary for different mailing(s) 12 depending on the respective characteristic of the mailing(s) 12. The controller 110 may be programmed to correlate the desired actions and franking criteria related to a corresponding characteristic of a respective mailing 12 with indicia, programmed in the controller, representing the characteristic of the mailing. Thus user identification of a specific indicia for a mailing 12 to the controller, such as via the user interface 116, causes the controller to access the suitable machine commands for performing the related actions and franking the mail pieces of the mailing according to the related criteria. As may be realized, the indicia of a given mailing may have any form (e.g. data stream, sound, pattern, light pattern) suitable for input, at least in part, via the user interface, but may for example also be identified by a sequence of characters (of any desired type). The controller 110 is programmed with an auto filling routine that may be accessed in response to use the user interface, as will be described below, to effect input of the sequent of characters identifying the indicia of a given mailing from entry of but a portion of the character sequence. The controller 110 may also have a voice recognition program 112V for user entry and selection of the indicia of the mailing to be processed by the mailing system as will also be described in greater detail below.

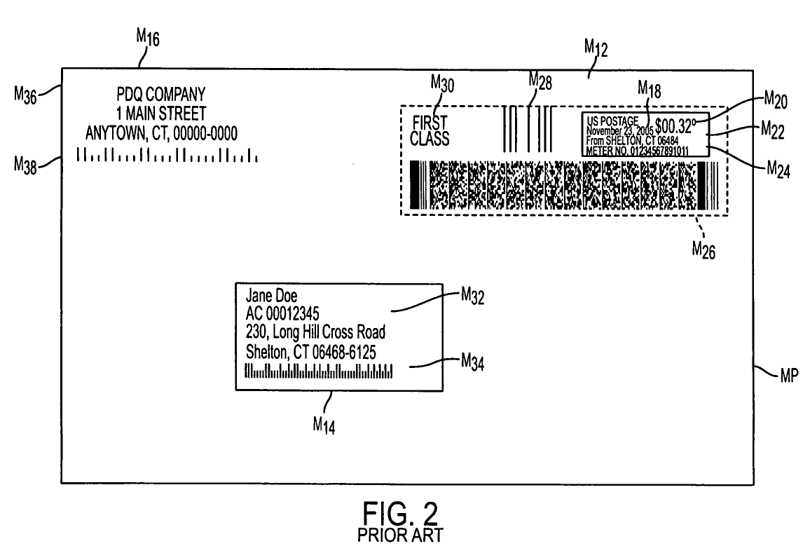

Referring to FIG. 2, there is shown an exemplary mail piece MP of a given mailing (similar to mailing 12) carried out with the mailing system 10. The mail piece MP is illustrated in this embodiment as an envelope, though in alternate embodiments mail piece MP may be any desired type of mail piece capable of being mailed using any desired mailing service from any mailing service provider/carrier. Mail piece MP may be labeled, by the mailing system, with various readable indicia. The indicia and labels may be registered in any suitable media, for example stored or embodied in electronic storage media (e.g. RFID), though in the embodiment shown the labels are printed matter on a surface of mail piece. The labels on the mail piece may be of any suitable type such as United States Postal Service (USPS) Information Based Indicia (IBI) M12, a destination address M14 and a return address M16. The IBI M12 has a date 18, a dollar amount M20, place of origin M22, postal meter serial number M24, encrypted bar code M26 and FIM M28 and class indication M30. The destination address M14 includes a written destination M32 and bar code M34 corresponding to the written destination M32. The return address M16 includes a written return M36 and bar code M38 corresponding to the written return M36.

In alternate embodiments, the labels or indicia thereof applied to the mail piece may vary as desired. As may be realized one or more of the information indicia of the labels applied to the mail piece, or whether the entire label itself is to be applied to the mail piece may depend on some characteristic of the mailing (similar to mailing 12) of which the mail piece is part.

For example, a characteristic of a given mailing, such as mailing 12 in FIG. 1, may be that all mail pieces within the mailing are to be sent as 2^{nd} class mail. Accordingly, the dollar amount indicia M20 and class indication M30 of the IBI label M12 for example, applied by mailing system 10 to each mail piece in the mailing would reflect the 2^{nd} class mail characteristic of the mailing. Similarly, any other desired label indicia to be applied by the mail system 10 to the mail pieces (similar to mail piece MP) of a machine may vary depending characteristics of the mailing. The system and manner in which the characteristics of a given mailing is indicated to the mail system controller 110 in order to have the controller operate the mailing system 10 and label the mail pieces 28 of the mailing with the appropriate indicate for the mailing, as well as to perform other relative activities applicable to the mailing, will be described in greater detail below.

Referring again to FIG. 1, the representative mailing system 10, as noted before, has a controller 110 and franking machine 100. Though only one franking machine is shown in FIG. 1, the system may have any number of franking machines. In this embodiment, the franking machine has a printing device for printing labels with various indicia (similar to the indicia on mail piece MP in FIG. 2) on mail pieces 28 of mailing(s) 12. An example of a suitable franking machine is described in U.S. patent application Ser. No. 11/045,216, filed Jan. 28, 2005, incorporated by reference herein in its entirety. Generally, the franking machine 100 has a printing media buffer 14, a printing media inserter 16, a media path 18, and a plurality of printheads 20, 22, 24, 26 positioned serially in the media path 18. Four printheads are shown in FIG. 1 for example purposes though any suitable number may be used. In the exemplary embodiment, the printheads 20-26 are staggered in a direction at an angle to the media path. Serial distances 50, 52, 54 corresponding to the printhead centerline may be at a common pitch or at different pitches and may overlap or coincide with each other. Similarly, stagger distances 56, 58, 60 corresponding to the printhead centerline may be at a common pitch or at different pitches and may overlap or coincide with each other such that the print ranges of each printhead may overlap wholly, partially or not at all. Printheads 20-26 may be movable substantially parallel to the feed direction indicated by arrow 46 or another direction (indicated by arrow 62) angled relative to the feed direction. Movement of the printheads may be under control of processor 30. The printheads may be part of a meter. Printheads 20-26 may be inkjet printheads or any suitable print head or suitable printing marker. In alternate embodiments, more or less printheads may be provided either stationary or movable. The printing media inserter 16 allows introduction of printing media into franking machine 100. The inserter 16 may transfer the printing media 12 from the printing media buffer 14 into the media path 18 or to the printing media buffer 14. A media feeder 44 feeds the printing media along the media path 18 in a media feed direction 46 at a media feed speed. The media feed speed may be fixed or variable and may be controlled by processor 30. A piece 28 of the printing media 12 traveling along the media path 18 is sequentially printed upon by each of or more than one of the plurality of printheads 20-26. An individual piece of media, for example, an envelope, may be printed upon by each printhead that is enabled to print. As noted before, one or more of the printheads may be movable within the media path. Also, in this embodiment, one or more of the printheads 20-26 may be movable outside the media path (in the direction indicated by arrow 62S) such as for servicing. A printhead service station 64 may be provided for this purpose as further described below.

The buffer 14, the printing media inserter 16, and the plurality of printheads 20-26 are controlled from processor and memory 30 for optimum printing media throughput. Processor 30 may direct or apportion data 34 to print heads 20-26 where print heads 20-26 may share data 34 representing a predetermined image 36. Different information may be printed on each media piece or envelope. Alternately, processor 30 may direct or apportion data 38 to print heads 20-26 where print heads 20-26 may share data 38 representing multiple images 40, 42 to be printed upon an individual piece of print media or separately directed to separate pieces of print media. Alternately, image(s) data may be processed and directed generally to print head(s) to be placed on piece(s) of media in any suitable combination. In this manner, printing information may be dynamically allocated among the printheads according to various parameters, for example, printhead capability, colors in a printhead, printhead resolution, media piece position, media type, media speed, or any other suitable parameter, in order to achieve optimum throughput. The speed of the inserter, buffer, and media path may be controlled in conjunction with the information sent to each printhead in order to achieve optimum throughput. The media path may travel at a variable speed or at a constant speed. The inserter, buffer, media path, and printheads may communicate with each other over a communication path 68, and may be operated by a controller or processor 30 under the control of one or more programs. In alternate embodiments the franking machine may have any other desired configuration.

Referring still to FIG. 1, controller 110 is operably connected to the franking machine 100. The controller 110 may be a local controller, for example integral to the franking machine 100 (possibly incorporated into machine controller 30) or in proximity to the franking machine. The controller 110 may also be a remote controller communicably connected to the franking machine 100 via a suitable communication link such as a local area network (LAN), public switched telephone network (PSTN), cellular link or any other desired communication network. The controller 110 may be PC based. In this embodiment, the controller 110 is shown as a single piece for example purposes, and in alternate embodiments the controller may comprise or be hosted on more than one suitable electronic device(s) (e.g. PCs, cell phones personal devices, etc.) that are networked by suitable communication links. The controller 110 has a program suite or module 112 with desired programming to allow the controller 110 to operate the franking machine 100 (i.e. generate and send suitable machine commands and receive data such as status, and feedback data from the franking machine). The controller 110 may also have an accounting portion 114, which may at least in part be includes in the programming module 112, for accounting funds applied to mail pieces 28 franked by the franking machine. The accounting portion 114 is arranged at least in part, in a postal security device (PSD) (not shown), that secures the accounting portion 114 of controller 110 from electronic and physical tampering. As noted before, the controller 110 may be communicably connected via a suitable and secured communication link to a remote account RA to resolve accounting for the fund amounts applied to mail pieces 28. For example, the remote account may authorize or provide a desired amount of funds, the amount of which may be registered in the accounting portion 114 of the controller, to carryout a certain number of mailings. The accounting portion 114 registers the depletion of funds as the amounts are respectively applied to each mail piece of the mailings, and causes the controller to communicate with the remote fund account for further funds upon reaching a predetermined amount threshold.

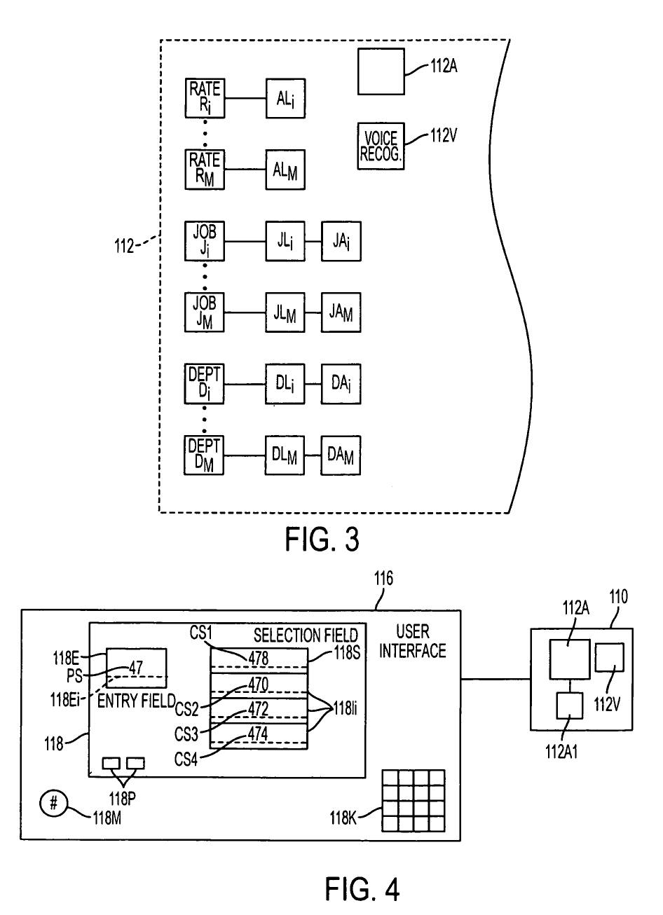

User interface with controller 100 is via user interface 116 (see FIG. 1). User interface 116 may be located as desired, such as on the franking machine 100, or proximate to controller 110 or may be at a remote location from both franking machine and controller, and linked to the controller by a suitable communication link. The controller program module 112 may include software (drivers) for operating the user interface 116. The user interface 116 schematically illustrated in FIG. 1, is a representative use interface and in alternate embodiments the user interface may have any other desired configuration. The user interface 116 generally has a display 118 and an input section 118K, 118M. The input section may for example have any desirable input architecture, keys corresponding to desired characters (e.g. a QWERTY keypad), a mouse or directional keys for navigating a cursor on the display screen, the display 118 may be a touch screen which may be used in conjunction of selection menus displayed by the controller program module 112 on display 118. The user interface 116 input section may also have a microphone 118M for voice commands. The program module 112 may include voice recognition software 112V (see also FIG. 3) connecting the signals generated by the microphone 118M in response to user voice inputs into electronic data embodying the voice input and display characters for display on screen 118 corresponding to the voice inputs.

As seen in FIG. 1, the controller 110 may be communicably connected to various client devices Ci, Cm, by communication link 120 which may be for example LAN, PSN, cell network, etc. The controller 110 software 112 may enable the controller to communicate with clients Ci, Cm, using any desired communication protocol, and allow the user interface (not shown) of the client devices to operate as remote user interfaces of the controller. The level of interface with the client devices may be established as desired, for example, some client devices may be provided with full access, in which case the command and information input available on the client device may be generally similar to that available when with user interface 116. Thus, a user may be able to input to controller 110 substantially the same information and commands as when using user interface 116. Other client devices that communicate with controller 110 may have reduced access levels, wherein a more limited number of commands and inputs for controller 110 may be available from the client device. For example, the client device may interface with controller 110 to obtain job status or tracking information from the controller but may not command the controller 110 to commence a mailing job. The client devices Ci-Cm may be any suitable electronic devices, such as PCS, personal device for example cell phones/communication devices. The controller software 112 may be arranged to generate interface features on the client user interface similar to the interface features provided on user interface 116. Thus, the manner of interface between the client devices Ci-Cm and controller 110, and between the user interfacing and controller 110 may be similar. As may be realized, one or more of the client devices Ci-Cm may correspond to different departments or sections of an organization that share the mailing system 10 to carry out mailings 12. As may also be realized, the characteristics of mailings from different departments may be different. For example, the funds for the mailings may be segregated between a number of departments, and hence, the accounting portion 114 of the controller is provided with suitable information to dispense funds from and/or account for funds dispensed for the mailing from a particular department.

Referring now to FIG. 3, there is shown a schematic view of a portion of the program module 112 of controller 110. As noted before, the controller 110 is programmed to frank mail pieces 28 of mailing(s) 12 and perform other activities in support of the mailing(s) according to some characteristics of the mailings. As also noted before, each mailing 12 may have a different characteristic so that the labeling of franked mail pieces from the given mailing, and other activities supporting the mail piece franking, are different for each mailing being processed by the mailing system 10. One example described before is mailings using different post classes (for example maligns using 1^{st} class mail and 2^{nd} class mail from the USPS). As seen in FIG. 3, the controller 110 may be programmed with the indicia related to different characteristics Ri-Rm, Ji-Jm, Di-Dm for different mailings to be performed by the mailing system. The indicia, and characteristics related thereto, shown in FIG. 3 are merely exemplary, and in alternate embodiments any desired indicia for any desired characteristic of a mailing may be programmed into the control. In the embodiment shown in FIG. 3, indicias are provided for post rate type Ri-Rm (i.e. post class), job type Ji-Jm and department (DEPT) Di-Dm (i.e. the department ordering the mailing be processed). As may be realized, the indicia Ri-Rm, Ji-Jm, Di-Dm may in effect form a user command which when input to controller as will be further described below, causes the controller programming to access a related command(s) or program sequence. For example, the controller 110 may be programmed with an algorithm/look up tables Ali-Alm, shown graphically in FIG. 3, to establish the appropriate postage amount for a given rate type indicia input. The program architecture correlated a given indicia Ri with the appropriate program sequence/algorithm Ali. In addition to the rate calculation algorithm, the program sequence may include other commands for the printing section to label the mail piece 28 of the given mailing with the proper postage amount. The other program sequenced corresponding to other mailing characteristic indicia Ji-Jm, Di-Dm may be configured as desired to perform the desired mailing. For example, the program sequence Jli-Jai corresponding to job type indicia may include rate calculation portions, labeling information portions for one or more of the labels applied to the mail pieces as well as accounting activity portions in the event post funds for mailing for different jobs are segregated. Similarly, the program sequences DAi-DAi corresponding to the DEPT type indicia Di may be configured to perform the desired mailing support activities for mailings from a given department.

As seen in FIG. 3, the indicias for similar or otherwise related characteristics of mailings may be grouped. This is shown schematically in FIG. 3, and may be accomplished in program module 112 by any suitable means. For example, the indicias may be stored in a designated memory registers, or may be identified as being related by a suitable comparative program routine.

Referring now to FIG. 4 there is shown a schematic view of the user interface 116 and controller 110 of mailing system 10. As noted before the user interface may be arranged in any desired manner allowing the user to input the mailing characteristic indicia Ri-Rm, Ji-Jm, Di-Dm to the controller 110 and effect the desired mailing. In the exemplary embodiment shown, the controller programming displays on display 118 of the user interface an entry field 118E. Any number of entry fields may be generated on the display. The entry field has character spaces 118Ei in which the user can enter characters using the keypad 118K, touch screen pads 118P or microphone 118M and voice recognition software 112V. The user may enter in the entry field the sequence of characters that identifies the indicia related to the mailing characteristic (e.g. rate, job, DEPT). As noted before, the controller program 112 has an auto-filling routine 112A that automatically identifies and/or displays for selection appropriate indicia from a partial sequence of characters entered in the entry field. As may be realized, the indicia for a mailing characteristic may be identified by a character sequence LS1-LS4. For example, DEPT indicia may be identified by department name, number or other desired character sequence selected to identify the indicia. Similarly, suitable character sequences may be used to identify the indicia for job or rate or any other mailing characteristic indicia. The auto-filing routine 112a of controller 110 registers a partial sequence PS entered in the entry field 118E of the display and has a suitable algorithm capable of identifying applicable indicia stored in the memory. Suitable examples of auto-filling routines are described in U.S. Pat. Nos. 5,845,300 and 6,922,810 incorporated by reference herein in their entirety. The auto-filling routine 112A may, upon identifying a single optimal indicia in response to the entry of the partial character sequence, complete the character sequence in the entry field. If multiple matches are identified (e.g. the character sequence for multiple indicias stored in program memory satisfy the partial sequence entered into the entry field) the auto-filling routine will cause the controller to generate a list of the character sequences for the indicias that satisfy the partial sequence. The controller program 112 may display this list in a selection field 118S having selectable menu features 118Si. As seen in FIG. 4, each menu feature may have the complete sequence Csi-CS4 identify the indicia. Selection of the menu feature inputs the indicia to the controller. In alternate embodiments, the display of the selection field may have any other desirable configurations. The auto-filling routine may arrange the indicia in the display according to sequencing of the characters (e.g. ascending/descending alphabetically or numerically) or based on a weighting algorithm 112A1. The weighting algorithm may be configured to account for use frequency, or expired time since last usage or both.

While particular embodiments have been described, various alternatives, modifications, variations, improvements, and substantial equivalents that are or may be presently unforeseen may arise to Applicant's or others skilled in the in the art. Accordingly, the appended claims as filed, and as they may be amended, are intended to embrace all such alternatives, modifications, variations, improvements and substantial equivalents.

What is claimed is:

1. A method for marking a mailpiece with a marking device, the method comprising:
providing the marking device with a processor and a user interface for inputting and displaying information;
entering in the user interface a partial sequence of characters from a complete sequence of characters, wherein the complete sequence of characters identifies a predetermined indicia related to a predetermined characteristic of the mailpiece;
with the processor, using the partial sequence to identify predetermined indicia stored in a memory of the processor that satisfy the partial sequence;
listing the predetermined indicia on a display of the user interface; and
selecting one of the listed predetermined indicia, wherein selection of the one listed predetermined indicia causes the processor to generate a corresponding command to the marking device.

2. The method according to claim 1, wherein the command is a print command causing the marking device to print a mark on the mailpiece related to the selected predetermined indicia.

3. The method according to claim 1, wherein the command causes the marking device to perform an activity regarding the mailpiece, and wherein the activity is related to the selected predetermined indicia.

4. The method according to claim 1, wherein the listing comprises with the processor weighing the predetermined indicia based on usage frequency of the partial sequence.

5. The method according to claim 1, further comprising programming the processor to identify the predetermined indicia based on usage frequency of the partial sequence and expired time since last prior use of the partial sequence.
